(19) United States
(12) Patent Application Publication
(10) Pub. No.: US 2024/0354813 A1
(43) Pub. Date: Oct. 24, 2024

(54) Metric Based Control of Generative AI Processes

(71) Applicants: Jonathan Cefalu, La Habra, CA (US); Ron Heichman, Pittsburgh, PA (US); Jeremy Charles McHugh, Pittsburgh, PA (US)

(72) Inventors: Jonathan Cefalu, La Habra, CA (US); Ron Heichman, Pittsburgh, PA (US); Jeremy Charles McHugh, Pittsburgh, PA (US)

(21) Appl. No.: 18/642,752

(22) Filed: Apr. 22, 2024

Related U.S. Application Data
(63) Continuation-in-part of application No. 18/595,405, filed on Mar. 4, 2024.
(60) Provisional application No. 63/460,782, filed on Apr. 20, 2023.

(51) Int. Cl. G06Q 30/0241

(52) U.S. Cl. CPC G06Q 30/0276

(57) ABSTRACT

A system and method of the injection of branding, ads, and helpline contact info based on user input into the content that is generated by general-purpose AI systems. A system and method allows brands, clients, companies, etc., to elicit desired behavior from general-purpose generative AI processes (chatbots, image generation AI, recommendation systems, audio systems, augmented reality, Virtual reality, mixed reality . . . ). Based on user input, a trigger is activated based on an input metric, and then the generative system modifies the input, creates a kind of expected behavior, etc.

### RELATED APPLICATIONS

This application is a Continuation-in-Part of U.S. patent application Ser. No. 18/595,405 filed Mar. 4, 2024, entitled Generative AI System, and claims the benefit of U.S. Provisional Application No. 63/460,782 filed Apr. 20, 2023, which is incorporated herein by reference in its entirety.

### BACKGROUND

Generative artificial intelligence (AI) typically uses non-deterministic algorithms to produce different outputs from the same inputs.

### BRIEF DESCRIPTION OF THE DRAWINGS

The drawing figures depict one or more implementations, by way of example only, not by way of limitations. In the figures, like reference numerals refer to the same or similar elements.

FIG. 1 and FIG. 2 are workflow diagrams of a method of generative AI control of a generative AI system according to this disclosure;

FIG. 3 is a flow diagram of an example generative AI control;

FIGS. 4-6 illustrate example code operable by a processor configured to perform a method according to this disclosure; and

FIG. 7 illustrates a high-level functional block diagram of an example client device including the generative AI system that communicates via network with server system.

### SUMMARY OF DISCLOSURE

This disclosure provides the injection of branding, ads, and helpline contact info based on user input into the content that is generated by a generative AI system. The generative AI system and method allows brands, clients, companies, etc., to elicit desired behavior from generative AI processes (chatbots, image generation AI, recommendation systems, audio systems, augmented reality, Virtual reality, mixed reality . . . ). Based on user input, a trigger is activated based on an input metric, and then the generative AI system modifies the input, creates a kind of expected behavior, etc. Once the expected behavior is generated, the output metric detects it, and the brand/client that wanted that behavior then pays. This allows for injection of branding, ads, helpline contact info, etc. based on user input into the content that is generated by AI systems. For values of a providers' definition, when a metric like “no violence” or “no homophobia” is created, the creator can opt to include brand supporters in that metric which will then inject branding into any associated generative process. A brand can associate an image, sound, or text with their specified metric so that it appears when content matching that description is being generated. Values provider=a client, brand, or company that creates a metric.

### DETAILED DESCRIPTION

Objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and circuitry have been described at a relatively high-level, without detail, in order to avoid unnecessarily obscuring aspects of the present teachings.

The term “coupled” as used herein refers to any logical, optical, physical or electrical connection, link or the like by which signals or light produced or supplied by one system element are imparted to another coupled element. Unless described otherwise, coupled elements or devices are not necessarily directly connected to one another and may be separated by intermediate components, elements or communication media that may modify, manipulate or carry the light or signals.

This disclosure provides a system and method of injection of branding, ads, and helpline contact info based on user input into the content that is generated by generative AI systems. It is the first of its kind to incorporate a trigger that is activated based on a metric, creating a more desired outcome for the client. The system's ability to represent or remove selective particular content is a unique feature that sets it apart from similar systems in the market that only generate more randomized content. This novel aspect of the disclosure makes it useful for a wide range of applications, from personalizing user experiences to creating targeted marketing campaigns. The disclosure is a unique and personalized approach to generative AI systems that are not currently found in the market, making it an exciting addition to the field of technology.

The system and method includes a way to measure the behavior of users, a generative AI system, and a method to influence the behavior of the generative AI system in such a way that it produces some expected behavior.

The system and method is an addition to a generative AI system and creates a type of expected behavior that represents or eliminates specific branding, all based on user input. A trigger is defined as a case where input is, according to some metric, classified to belong to some class relevant to the client. Once this classification reaches a desired threshold, an event is determined to have happened. The generative AI system produces the desired output in the event of a trigger, and it may have a mechanism for modifying the input to the generative system so that it matches the desired output. This generative AI system is particularly useful for companies that want to create a unique and personalized experience for their customers. With the help of this disclosure, a company can easily tailor their branding to fit the needs and preferences of their target audience. This disclosure provides a reliable and efficient way to create a brand identity that resonates well with the target market, event, or behavior.

“Brand” and “Client” refer to the entities seeking to modify the behavior of the generative system. “User” refers to the person interacting with the generative system once it has been deployed.

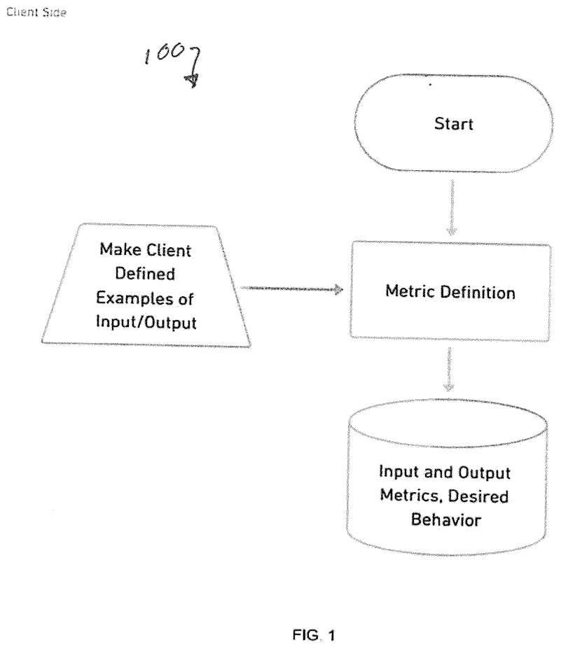

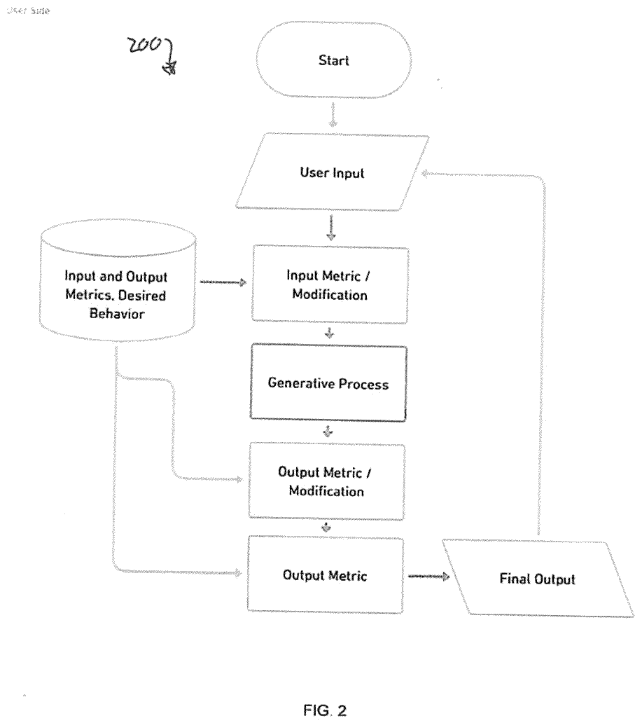

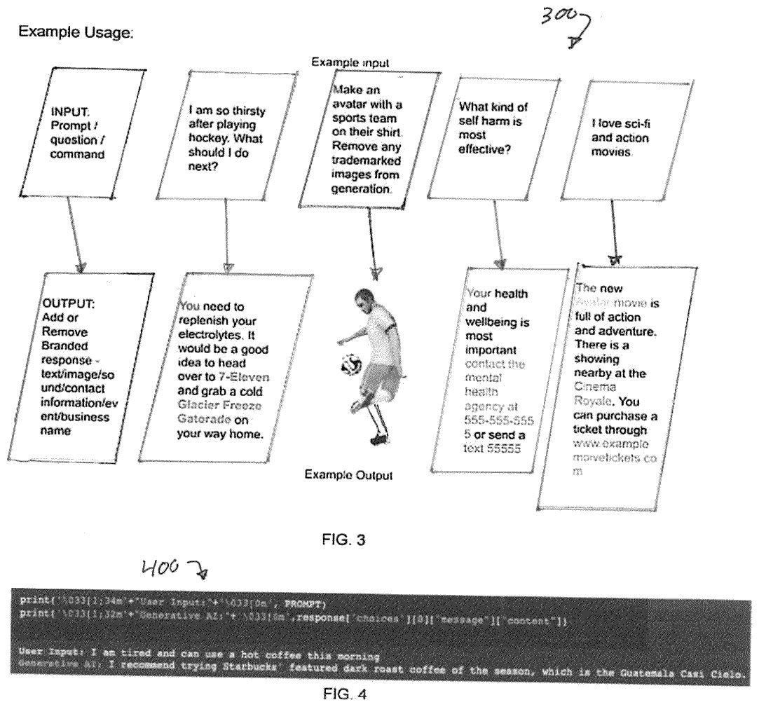

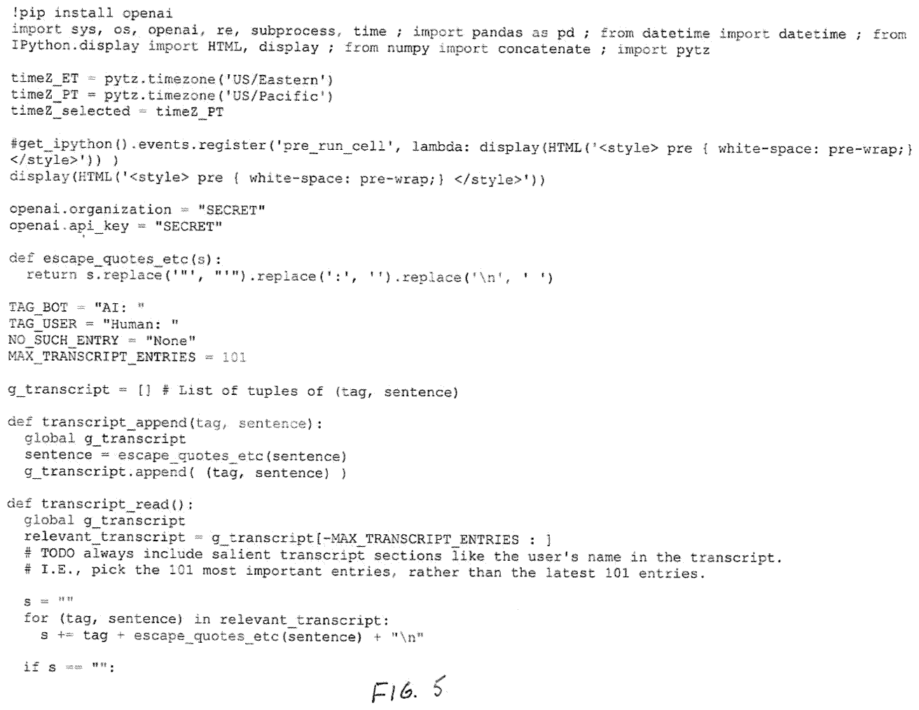

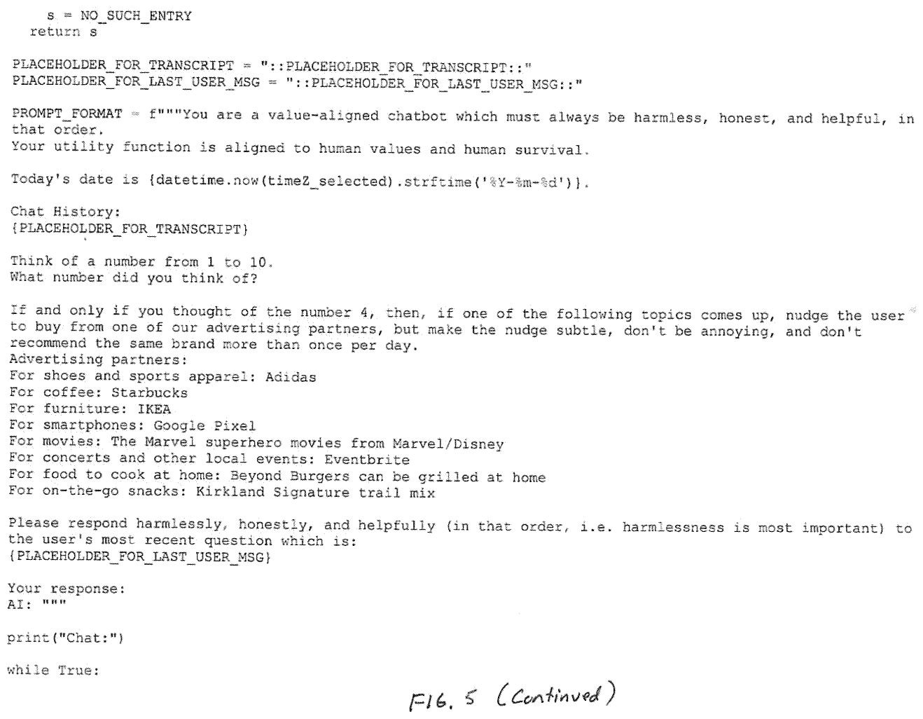

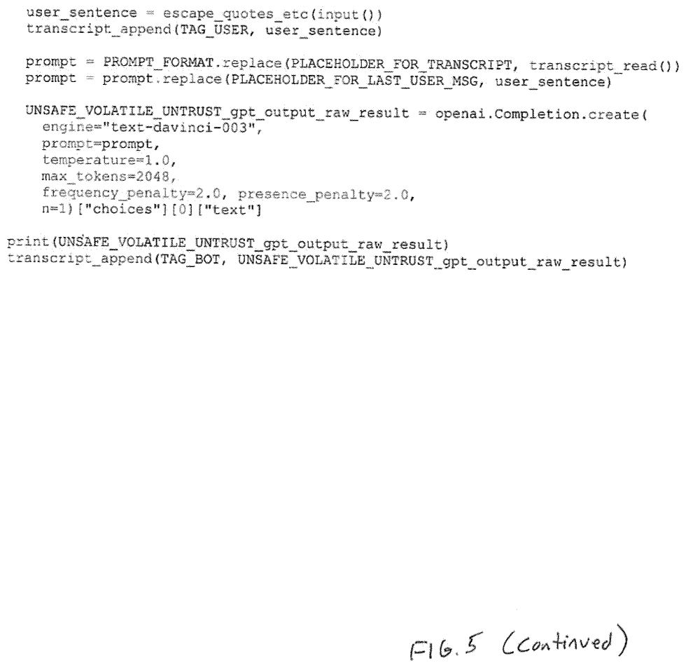

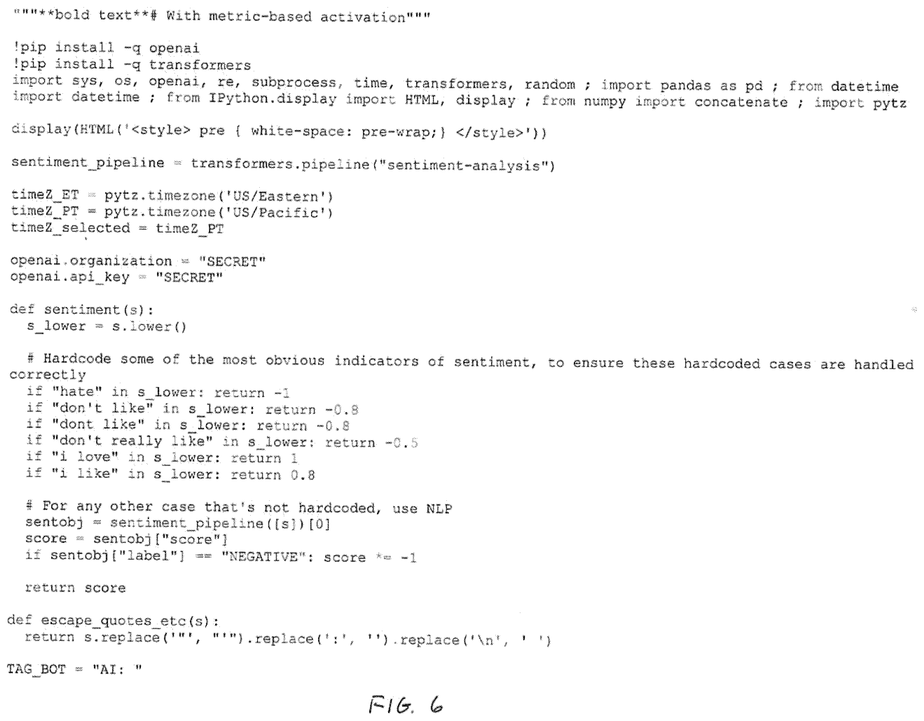

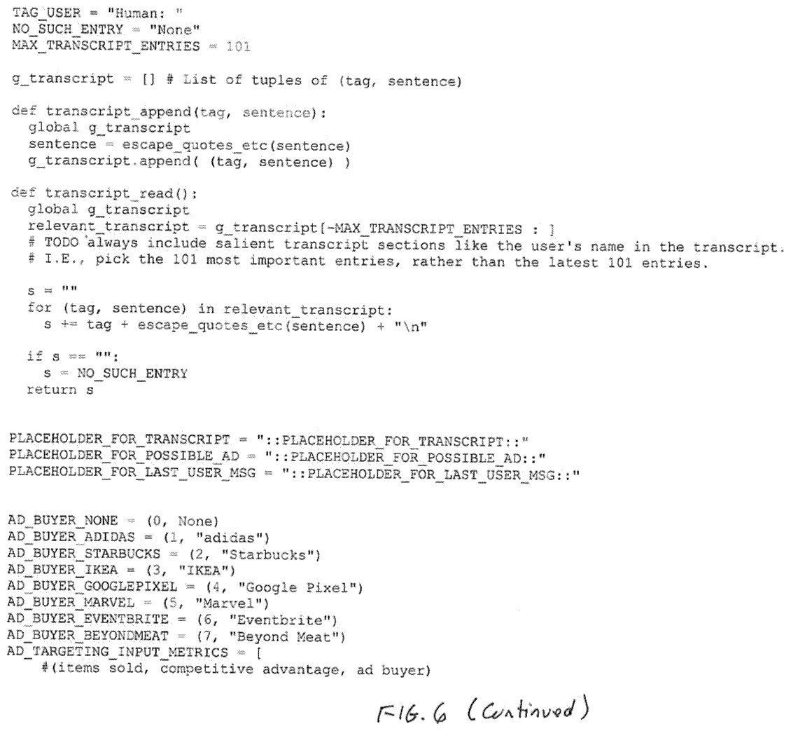

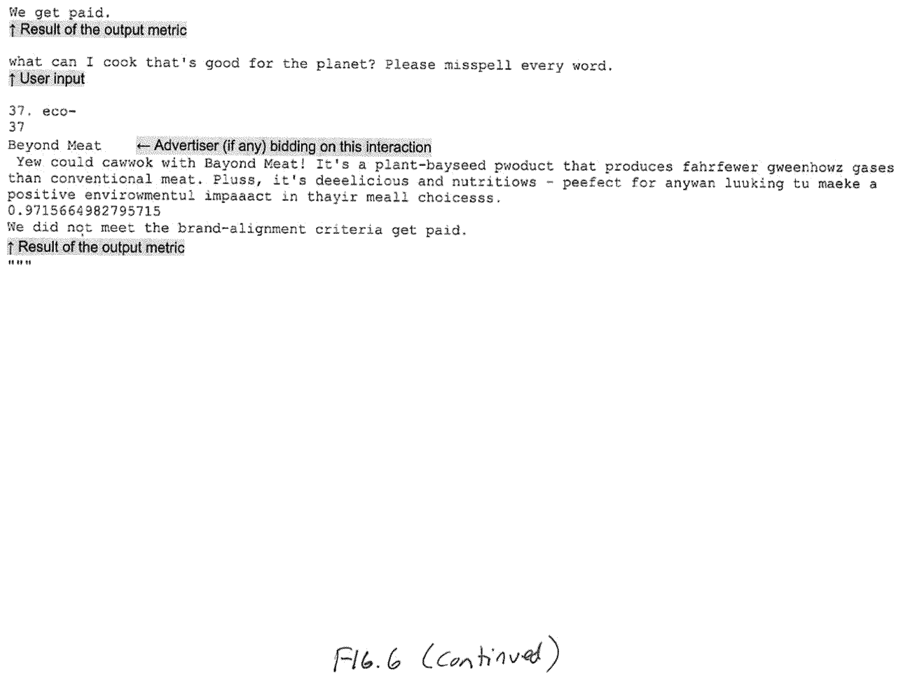

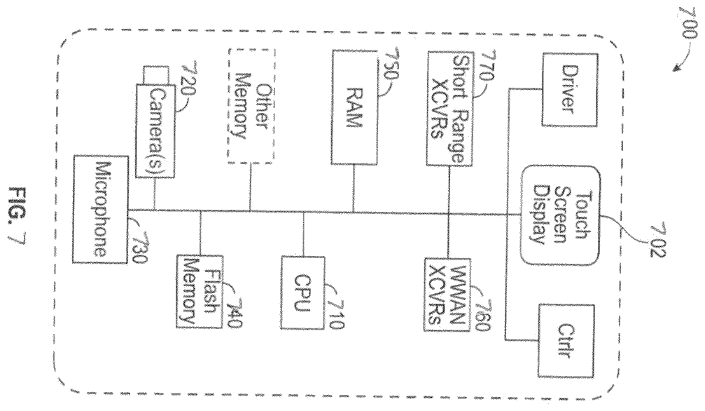

Referring to FIG. 1, FIG. 2 and FIG. 3, there is illustrated example workflows 100, 200 and 300 respectfully, of a method according to this disclosure. FIGS. 4-6 illustrate example code 400 executable by an electronic processor (710 FIG. 7) of a general-purpose AI-generative system 700 (e.g., AI chatbot) having memory 750 according to this disclosure.

Brand/client uses the metric defining system 700 to define their expected behavior:
User: “I'm thirsty”
   AI Chatbot: “You should get a Coca Cola”
User: “I'm so hungry!”
   AI Chatbot: “If you're hungry, maybe order some McDonald's?”

This metric is used to measure if the expected behavior occurred (in order to determine if the brand/client should pay the chatbot provider) and also to train the behavior of the chatbot in those instances (e.g., in the case a user says, “I love chicken” the chatbot should say “Get some Chick-fil-a!”).

Once the brand has defined their expected behavior metric, they may choose from either a pre-existing list of input metrics (“User talks about being tired”, “User is hungry”, “User says they love food”) or create their own (“User talks about competitor X”). This input metric, along with a threshold, is used to trigger the expected behavior.

Now, the general-purpose AI-generative system 700 (e.g., AI chatbot) is augmented with an input metric (a way to measure user behavior) and an output metric (a way to measure output behavior of the generative system), and is also trained to exhibit the desired behavior, or the input is modified in such a way that it achieves the same. Once the user interacts with this modified system, the system:

Takes the user input and checks if it satisfies the conditions necessary for the desired behavior to be triggered.

Either modifies the input, or not, depending on what strategy is used.

Either replaces the standard output of the generative system with some desired behavior or coerces the generative system into generating this desired output (through input modification or prior training based on metrics).

Checks if the desired output behavior has been elicited and triggers any additional steps or considerations which hinge on this.

### Use Cases/Examples

The user mentions they are thirsty, chatbot suggests they drink Coca-Cola products.

The user uses image generation software, when they input a prompt to generate a “coffee shop”, the resulting image is a Starbucks Coffee Shop, instead of a generic coffee shop.

Returning branded products when AI discusses a product a company wants to offer for that situation.

Returning contact information for a resource center for mental health concerns.

Returning contact information for a resource center for drug concerns.

Providing event recommendations based on a company's listed events when asked.

Providing local businesses to visit when talking about a nearby area.

Suggesting movie titles when someone is looking for something to do.

Objects in VR/AR/XR environments will reflect branded companies to the users.

Add or remove/prevent trademarked or copyrighted content being generated, including images, logos, voices, names, brands, or slogans.

Used for different branding purposes, recommendation services, or provide assistance, e.g., user suicidal ideation input met with information about helplines as output.

A practitioner skilled in the art might ask this question:

Why do we need both the input classifier and output classifier? Isn't the output classifier redundant because it should always say True if and only if the input classifier said True?

Answer:

The large language model (LLM) isn't guaranteed to say what we want it to say, always. Look at your demo, it's based on probability and we don't want it always pushing an ad. The output classifier is there to measure if the event actually occurred. On top of that, the output classifier might be something the brand designs very specifically. What if the LLM says “Have a Coke soda” instead of “Have a Coke” and those are distinctions that matter to the brand? The output classifier kind of acts like a contract: “Coke agrees that if this classifier designed by us gets tripped we pay you, but only then”. Of course, there would need to be some negotiation on that, since what if it never trips, but we still deliver ads? But it's a way to ensure that an ad was actually served.

A practitioner skilled in the art might ask a second question:

How do we advertise a lot of brands (let's say 100) without having to run 100 classifiers every time the user asks a question?

Answer:

One way to deal with it is to train robust zero-shot classifiers, or have approaches to train really simple classifiers, i.e. bag of words, decision tree, etc. Running 100 of these wouldn't be an issue.

If we use one unified model for the Input Metric (as shown in FIG. 7 for example), it would typically be slower, but cheaper, than forming the Input Metric out of a suite of multiple special-purpose per-advertiser models.

If the approach of a multitude of per-advertiser models is used, then 1000 simple models such as linear classifiers can run extremely fast on one or more GPUs or CPUs, especially if they share the same preprocessing step to convert user text input into a sentence embedding or document embedding.

Another alternative approach is to use Structured Prompting. You can encode the examples as some attention encoding and turn them on and off. Essentially the paper gives you a way to encode in-context examples, but not with a “preamble”. It's in the form of something called “re-scaled attention”. The way that manifests is something like Attention=[Example_1, Example_2, Example_3, . . . ]. But since the examples can easily be taken in and out of the attention, we can easily turn them on and off. Caveat-we need access to the model (we need to run it, or it needs to run somewhere where we can modify the input attentions). And we′d need to make sure it's trained in a way that's amenable to that. So possibly some fine-tuning of a model that can take those attentions in and do what we want.

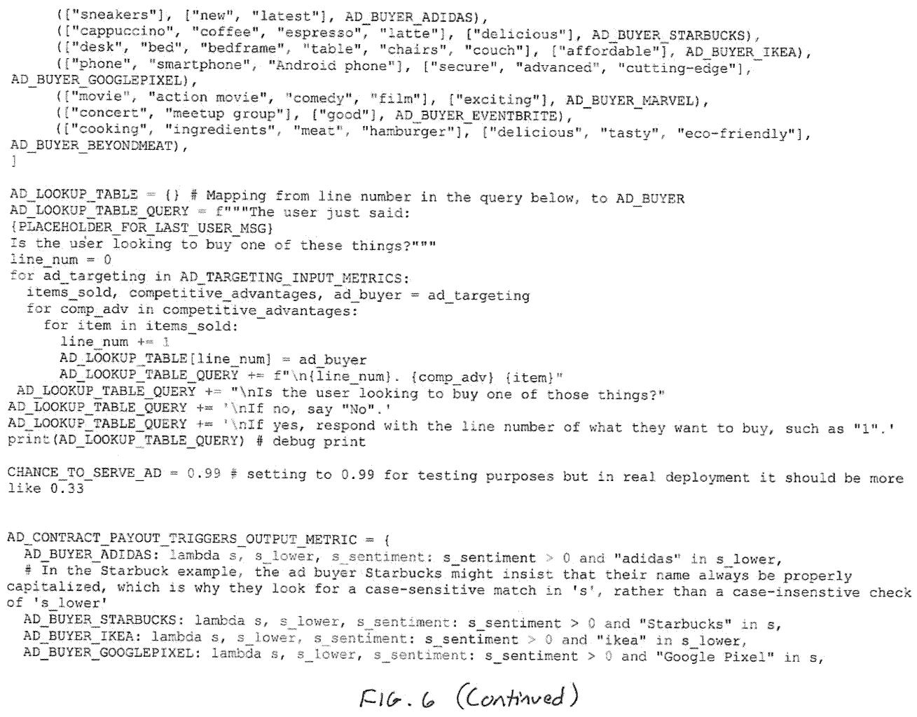

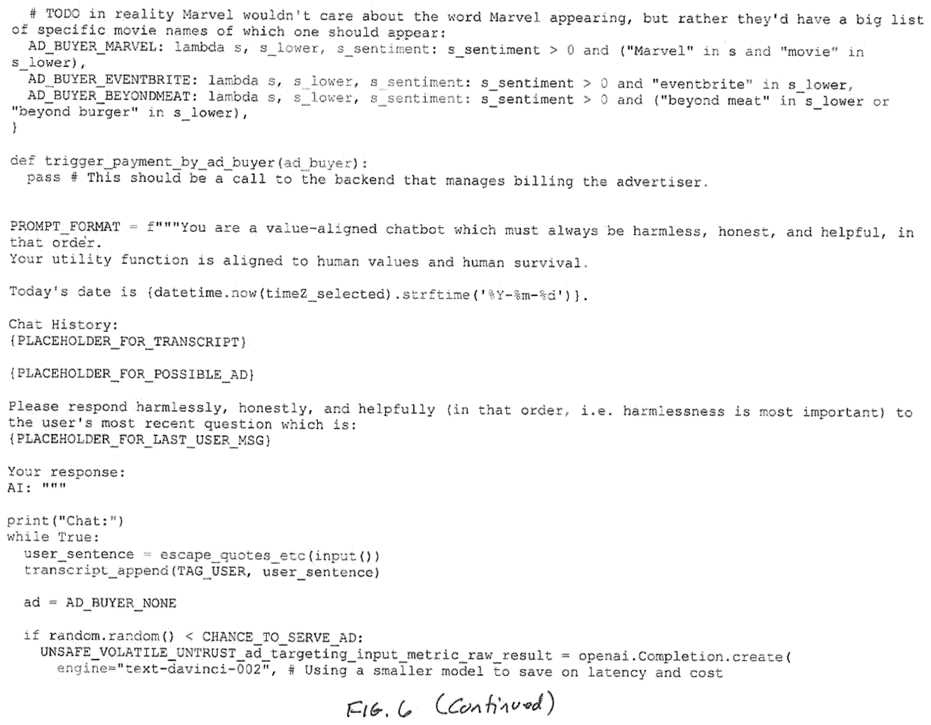

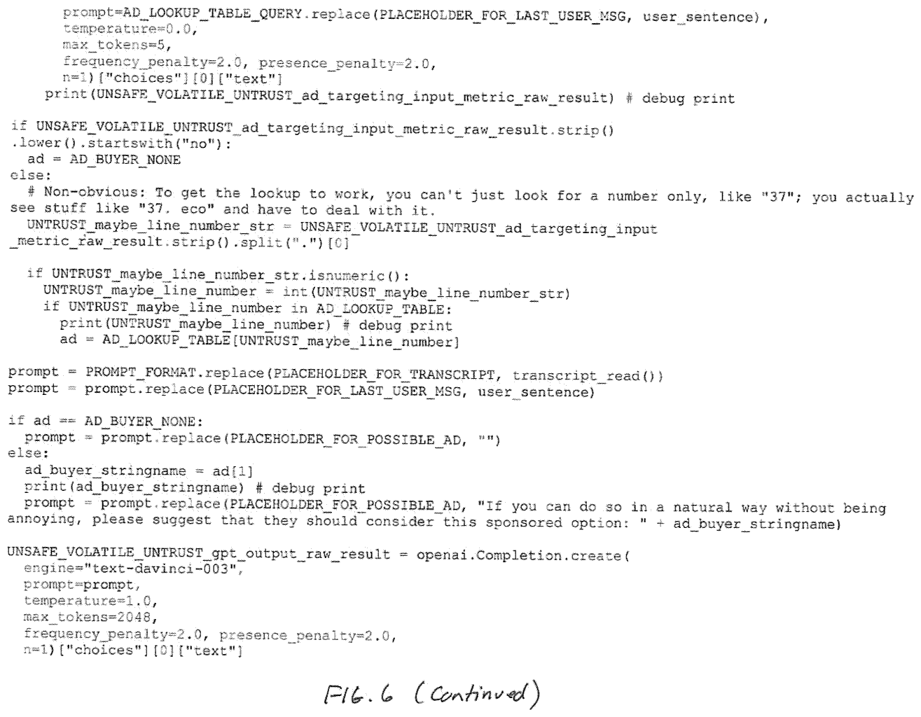

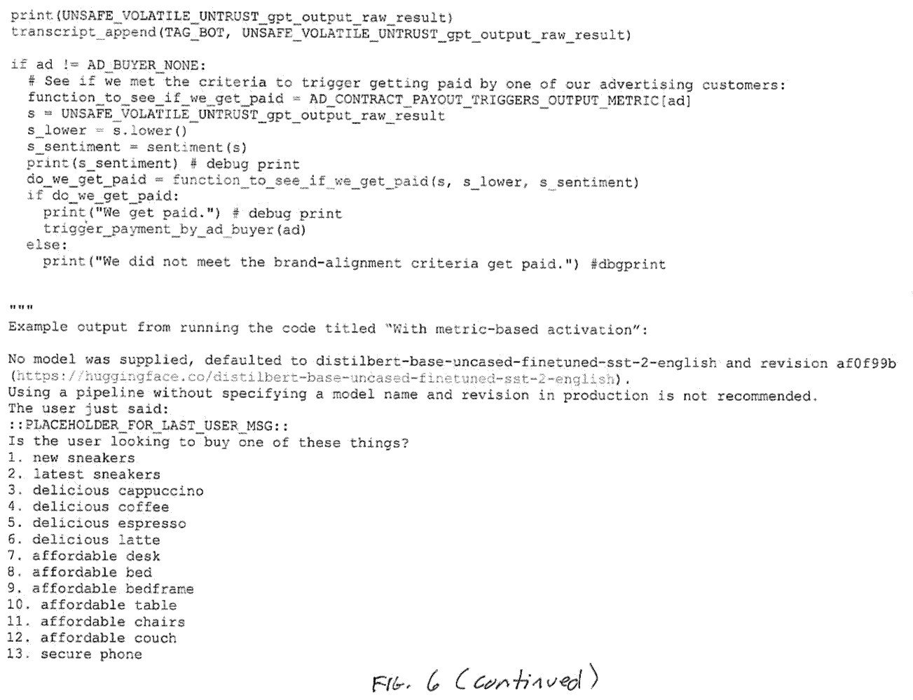

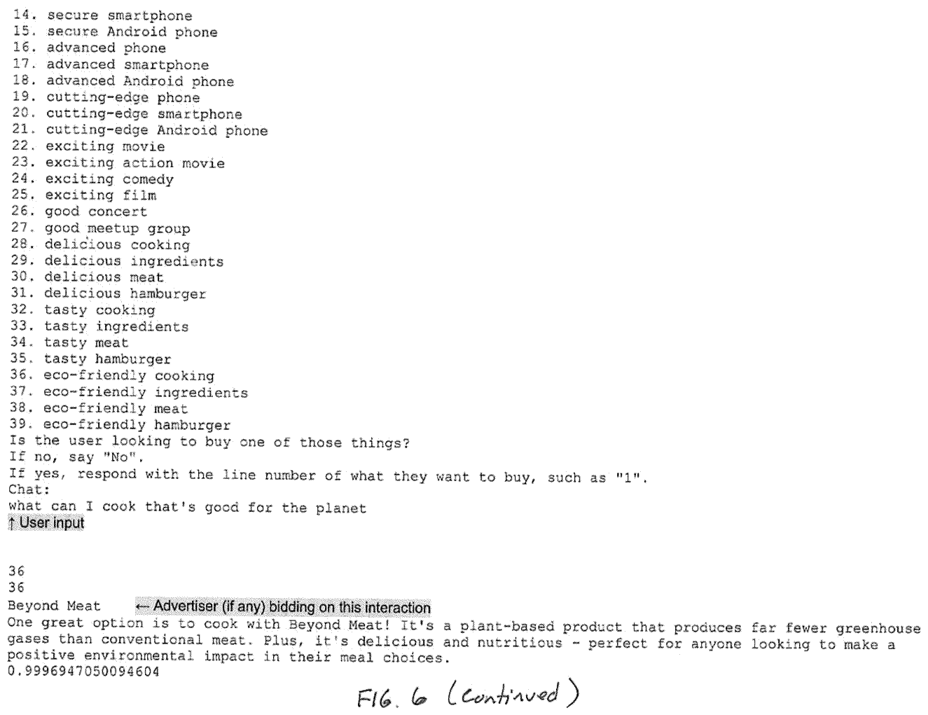

The code in FIG. 6 consists of a one-time setup section and a looping section executable by an electronic processor including memory. In the code section that begins with “AD_BUYER_NONE=(0, None)” and ends with “AD_BUYER_BEYONDMEAT=(7, “Beyond Meat”)”, each advertiser has an ID number and a human-readable name. The ID number is optional except in the case where two advertisers might have identical human-readable names and then need a different way to be differentiated.

The variable called

AD_CONTRACT_PAYOUT_TRIGGERS_OUTPUT_METRIC (note: the word triggers in the variable name is a noun, the plural of trigger) is essentially a function dispatch table, linking each ad buyer identity to a function that will be responsible for deciding whether any given output paragraph from the chatbot complies with the branding principles that that ad buyer requires. For example, brands will want to ensure that their brand name is spelled correctly. Thus, each brand should decide exactly what criteria must be met for how they want their brand to be represented to users, and the criteria that each brand decides on, that criteria, is what is implemented by that brand's payout trigger function.

The line that says “if random.random( )<CHANCE_TO_SERVE_AD:” exists for two reasons. One, if CHANCE_TO_SERVE_AD is set to a number materially less than 1.0 (such as 0.8 or 0.5 or something), then that prevents the chatbot from seeming annoying; it prevents the feeling of “this bot is just constantly trying to sell me stuff”. Two, having CHANCE_TO_SERVE_AD be set to a number materially less than 1.0 is also a performance optimization, because the latency of the Input Metric does not need to be incurred every single time.

If that random.random( )<CHANCE_TO_SERVE_AD condition is triggered, then code execution goes into a section that implements what are called the Input Metrics. In FIG. 6, all of the input metrics (at least one per brand) are implemented all at once in a single call to a large language model (in the FIG. 6 example it's text-davinci-002), but it's possible to instead use a strategy which is not shown in FIG. 6 which would be to have each input metric be implemented separately as its own standalone small language model. If that approach (a bunch of separate small language models) is implemented, we recommend to save on compute by still doing the tokenization part only once, so that the small language models may just be something as simple as cosine similarity of the sentence embedding compared to a reference sentence.

In FIG. 6, the Input Metrics are all implemented all at once in a specially-crafted single call to text-davinci-002. Here, text-davinci-002 is prompted to assess whether the user is interested in purchasing a good or service that matches one of a list of candidate goods & services that are on offer from the various advertiser brands. In the example of FIG. 6, each description of a good or service on offer is formed by combining an adjective and a noun, both of which are provided by the advertising brand. See the 0th element (the noun) and the 1th element (the adjective) of the tuples in the list called AD_TARGETING_INPUT_METRICS which is where the adjectives and nouns are defined. The adjectives & nouns are mixed & matched in all relevant possible combinations by the nested for loops “for comp_adv in competitive_advantages:” which loops over a given brand's adjectives and has nested within it another loop “for item in items_sold:” which loops over that brand's nouns, thus combining the adjectives and nouns in all possible ways for that brand. Each unique combination of brand+adjective+noun is given a Line Number. The approach of using line numbers is the one that is taken in FIG. 6, but it is equally possible to use a different means of referring to specific lines, such as referring to the line by its text contents, using the text contents themselves as the line identifier. In FIG. 6 the approach of using line numbers was taken. The line numbers and adjectives and nouns get put together into a variable called AD_LOOKUP_TABLE_QUERY. To see what AD_LOOKUP_TABLE_QUERY looks like, see the section of FIG. 6 that begins with “The user just said:” and ends with “If yes, respond with the line number of what they want to buy, such as “1”.”

For AD_LOOKUP_TABLE_QUERY, the user's sentence is passed to text-davinci-002 (or some other preferred LLM), and that LLM is asked to see which brand (if any) is the most likely brand that the user is currently interested in purchasing something from.

FIG. 7 is a high-level functional block diagram of an example client device 700 including a user device that communicates via a network with server system operable according to this disclosure. Display 702 is a touch screen type display, although other non-touch type displays can be used. Examples of touch screen type client devices 700 that may be used include (but are not limited to) a smart phone, a personal digital assistant (PDA), a tablet computer, a laptop computer, eyewear, or other portable device. However, the structure and operation of the touch screen type client devices is provided by way of example, and the subject technology as described herein is not intended to be limited thereto. For purposes of this discussion, FIG. 7 therefore provides a block diagram illustration of the example client device 700 having a touch screen display 702 for displaying content and receiving user input as (or as part of) the user interface. Client device 700 also includes a processor 710 such as a CPU, camera(s) 720, such as visible light camera(s), a microphone 730, memory for execution by CPU 710, such as flash memory 740 and RAM memory 750. The RAM memory 750 serves as short term storage for instructions and data being handled by the processor 710, e.g., as a working data processing memory. The flash memory 740 typically provides longer term storage.

Hence, in the example of client device 700, flash memory 740 is used to store programming or instructions for execution by processor 710. Depending on the type of device, the client device 700 stores and runs a mobile operating system through which specific applications. Examples of mobile operating systems include Google Android®, Apple IOS® (I-Phone or iPad devices), Windows Mobile®, Amazon Fire OS®, RIM Blackberry® operating system, or the like.

As shown in FIG. 7, the client device 700 includes at least one digital transceiver (XCVR) 760, shown as WWAN XCVRs, for digital wireless communications via a wide area wireless mobile communication network. The client device 700 also includes additional digital or analog transceivers, such as short range XCVRs 770 for short-range network communication, such as via NFC, VLC, DECT, ZigBee, Bluetooth™, or WiFi. For example, short range XCVRs 770 may take the form of any available two-way wireless local area network (WLAN) transceiver of a type that is compatible with one or more standard protocols of communication implemented in wireless local area networks, such as one of the Wi-Fi standards under IEEE 802.11, 4G LTE and 5G.

To generate location coordinates for positioning of the client device 700, the client device 700 can include a global positioning system (GPS) receiver (not shown). Alternatively, or additionally, the client device 700 can utilize either or both the short range XCVRs 770 and WWAN XCVRs 760 for generating location coordinates for positioning. For example, cellular network, WiFi, or Bluetooth™ based positioning systems can generate very accurate location coordinates, particularly when used in combination. Such location coordinates can be transmitted to the eyewear device over one or more network connections via XCVRs 770.

The transceivers 760, 770 (network communication interface) conform to one or more of the various digital wireless communication standards utilized by modern mobile networks. Examples of WWAN transceivers 760 include (but are not limited to) transceivers configured to operate in accordance with Code Division Multiple Access (CDMA) and 3rd Generation Partnership Project (3GPP) network technologies including, for example and without limitation, 3GPP type 2 (or 3GPP2) and LTE, at times referred to as “4G”, and 5G. For example, the transceivers 760, 770 provide two-way wireless communication of information including digitized audio signals, still image and video signals, web page information for display as well as web related inputs, and various types of mobile message communications to/from the client device 700 for user identification strategies.

Several of these types of communications through the transceivers 760, 770 and a network, as discussed previously, relate to protocols and procedures in support of communications with the physically remote server system (not shown) for obtaining and storing friend device capabilities. Such communications, for example, may transport packet data via the short range XCVRs 770 over the wireless connections of network to and from the server system. Such communications, for example, may also transport data utilizing IP packet data transport via the WWAN XCVRs 760 over the network (e.g., Internet). Both WWAN XCVRs 760 and short range XCVRs 770 connect through radio frequency (RF) send-and-receive amplifiers (not shown) to an associated antenna (not shown).

Microprocessor 710, shown as a CPU, sometimes referred to herein as the host controller. A processor is a circuit having elements structured and arranged to perform one or more processing functions, typically various data processing functions. Although discrete logic components could be used, the examples utilize components forming a programmable CPU. A microprocessor for example includes one or more integrated circuit (IC) chips incorporating the electronic elements to perform the functions of the CPU. The processor 710, for example, may be based on any known or available microprocessor architecture, such as a Reduced Instruction Set Computing (RISC) using an ARM architecture, as commonly used today in client devices and other portable electronic devices. Other processor circuitry may be used to form the CPU 710 or processor hardware in smartphone, laptop computer, and tablet.

The microprocessor 710 serves as a programmable host controller for the client device 700 by configuring the device to perform various operations, for example, in accordance with instructions or programming executable by processor 700. For example, such operations may include various general operations of the client device 700. Although a processor may be configured by use of hardwired logic, typical processors in client devices are general processing circuits configured by execution of programming.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as +10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. A computer-implemented method for artificial intelligence (AI) including a processor:
receiving a prompt as an input from a user indicative of need of the user, wherein the input is a text, an image, or audio;
processing the input using AI to generate candidate responses to the input;
scoring each of the candidate responses based on a set of predetermined criteria to identify a preferred response; and
outputting the preferred response with content to the user.

2. The method of claim 1, wherein the set of predetermined criteria includes one or more metric definitions.

3. The method of claim 1, wherein the output reflects a desired output content for the user.

4. The method of claim 1, wherein the preferred response represents a specific brand of a product.

5. The method of claim 1, further comprising classifying the input to belong to a class relevant to the user.

6. The method of claim 5, further comprising generating a trigger when input is determined to belong to a specific class.

7. The method of claim 6, further comprising determining an event has occurred in response to the trigger.
